(19) United States
(12) Patent Application Publication
(10) Pub. No.: US 2024/0142146 A1
(43) Pub. Date: May 2, 2024

(54) Modular Cold Climate Heat Pump System with Multi-Segment Heat Exchanger

(71) Applicant: Alliance for Sustainable Energy, LLC, Golden, CO (US)

(72) Inventors: Eric KOZUBAL, Superior, CO (US); Jason David WOODS, Boulder, CO (US)

(21) Appl. No.: 18/494,306

(22) Filed: Oct. 25, 2023

Related U.S. Application Data
(60) Provisional application No. 63/419,396, filed on Oct. 26, 2022.
(60) Provisional application No. 63/516,279, filed on Jul. 28, 2023.

(51) Int. Cl. F25B 25/00; F24D 5/12; F24D 17/02; F25B 30/02; F25B 40/02; F25B 40/04

(52) U.S. Cl. CPC F25B 25/005; F24D 5/12; F24D 17/02; F25B 30/02; F25B 40/02; F25B 40/04

(57) ABSTRACT

A modular cold climate heat pump system which, in some embodiments includes a multi-segment heat exchanger. The modular cold climate heat pump system includes a heat pump module, a thermal energy storage module, and at least one end use module. Exemplary end uses include heating, ventilation, and air conditioning applications or domestic hot water heating. The thermal energy storage module may enable the heat pump module to continue operating even during temperatures below freezing.

### CROSS-REFERENCE TO RELATED APPLICATIONS

This application claims priority to U.S. Provisional Patent Application No. 63/419,396 filed on Oct. 26, 2022, and U.S. Provisional Patent Application No. 63/516,279 filed on Jul. 28, 2023, the contents of which are incorporated herein by reference in their entirety.

### CONTRACTUAL ORIGIN

This invention was made with United States government support under Contract No. DE-AC36-08GO28308 awarded by the U.S. Department of Energy. The United States government has certain rights in this invention.

### BACKGROUND

Most cold climate heat pumps for indoor space heating suffer from capacity and efficiency degradation when temperatures drop below approximately 17° F. and often require backup heating (either electric or gas) which draw a lot of power, especially when it is cold outside. Furthermore, defrost cycles for cold climate heat pumps often cause the system to draw heat back out of the building, which further reduces heating capacity and energy efficiency. Thus, there remains a need for improved heat pumps which are operable in cold climates.

### SUMMARY

An aspect of the present disclosure is a modular cold climate heat pump system, the system including a heat pump module including a refrigerant, a thermal energy storage (TES) module in thermal communication with the heat pump module via a first connection, and an end use module in thermal communication with the heat pump module via a second connection, in which the first connection and the second connection include a heat transfer fluid, and the refrigerant and the heat transfer fluid are in thermal communication in the heat pump module. In some embodiments, the heat transfer fluid includes at least one of ethylene glycol or propylene glycol. In some embodiments, the end use module includes an air handling unit module configured to heat an airstream. In some embodiments, the end use module includes a hot water tank, and the hot water tank is configured to heat a water stream. In some embodiments, the TES module includes a phase change material, and the phase change material includes a salt hydrate. In some embodiments, the heat pump module includes a valve manifold, the valve manifold is configured to direct the heat transfer fluid to the first connection or the second connection, and the TES module is configured to provide heat to the end use module via the first connection and the second connection. In some embodiments, the heat pump module includes a coil, and the coil is configured to receive heat from the TES module via the first connection. In some embodiments, the refrigerant includes at least one of R290 (propane), R134a, R410A, R454B, R448A/R449A, R452B, R1234yf, R32, R717 (ammonia), or R744 (carbon dioxide). In some embodiments, the heat pump module includes a multi-segmented heat exchanger (MSHX) device which includes a first heat exchanger, a second heat exchanger, and a third heat exchanger, in which the first heat exchanger, the second heat exchanger, and the third heat exchanger flow through at least one brazed plate, and he first heat exchanger, the second heat exchanger, and the third heat exchanger are in thermal communication with the refrigerant. In some embodiments, the first heat exchanger is configured to de-superheat the refrigerant resulting in a de-superheated refrigerant, the de-superheated refrigerant is configured to heat the heat transfer fluid resulting in a heated heat transfer fluid, and the heated heat transfer fluid is configured to heat the end use module via the second connection. In some embodiments, the end use module includes a hot water tank. In some embodiments, the second heat exchanger is configured to condense the refrigerant resulting in a condensed refrigerant, the condensed refrigerant is configured to heat the heat transfer fluid resulting in a heated heat transfer fluid, and the heated heat transfer fluid is configured to heat the end use module via the second connection. In some embodiments, the third heat exchanger is configured to sub-cool the refrigerant resulting in a subcooled refrigerant, the subcooled refrigerant is configured to heat the heat transfer fluid resulting in a heated heat transfer fluid, and the heated heat transfer fluid is configured to heat the TES module via the second connection.

An aspect of the present disclosure is a multi-segmented heat exchanger (MSHX) device including a first heat exchanger, a second heat exchanger, and a third heat exchanger, in which the first heat exchanger, the second heat exchanger, and the third heat exchanger flow through at least one brazed plate, and the first heat exchanger, the second heat exchanger, and the third heat exchanger are in thermal communication with a refrigerant and a heat transfer fluid. In some embodiments, the first heat exchanger is configured to de-superheat the refrigerant resulting in a de-superheated refrigerant, the de-superheated refrigerant is configured to heat the heat transfer fluid resulting in a heated heat transfer fluid, and the heated heat transfer fluid is configured to heat an end use module. In some embodiments, the end use module includes a hot water tank. In some embodiments, the second heat exchanger is configured to condense the refrigerant resulting in a condensed refrigerant, the condensed refrigerant is configured to heat the heat transfer fluid resulting in a heated heat transfer fluid, and the heated heat transfer fluid is configured to heat an end use module. In some embodiments, the end use module includes an air handing unit (AHU) module. In some embodiments, the third heat exchanger is configured to sub-cool the refrigerant resulting in a subcooled refrigerant, the subcooled refrigerant is configured to heat the heat transfer fluid resulting in a heated heat transfer fluid, and the heated heat transfer fluid is configured to heat a thermal energy storage module. In some embodiments, the refrigerant includes at least one of R290 (propane), R134a, R410A, R454B, R448A/R449A, R452B, R1234yf, R32, R717 (ammonia), or R744 (carbon dioxide).

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a modular cold climate heat pump (ccHP) system, according to some aspects of the present disclosure.

FIG. 2 illustrates a heat pump module for use within a modular ccHP system, according to some aspects of the present disclosure.

FIG. 3A illustrates the performance of three heat exchangers within the heat pump module of a modular ccHP system and FIG. 3B illustrates a temperature/entropy diagram illustrating how the sub-cooler extracts more heat from the refrigerant, according to some aspects of the present disclosure.

FIG. 4 illustrates a multi-segment heat exchanger (MSHX) integrated into the heat pump module of the modular ccHP system, according to some aspects of the present disclosure.

FIG. 5 illustrates a first embodiment of an MSHX inner refrigerant and fluid flow network, according to some aspects of the present disclosure.

FIG. 6 illustrates a second embodiment of an MSHX inner refrigerant and fluid flow network, according to some aspects of the present disclosure.

### REFERENCE NUMERALS

100 . . . system
105 . . . heat pump module
110 . . . air handling unit (AHU) module
115 . . . thermal energy storage (TES) module
120 . . . hot water tank
125 . . . AAHU coil
130 . . . blower
135 . . . airstream
137 . . . valve
140 . . . fan
145 . . . water stream
150 . . . heat pump coil
155 . . . exhaust air
160 . . . first connection
165 . . . second connection
167 . . . heat transfer fluid
170 . . . compressor
175 . . . heat exchanger
180 . . . valve manifold
185 . . . multi-segmented heat exchanger
190 . . . expansion valve
195 . . . refrigerant stream

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to a modular cold climate heat pump (ccHP) system which can serve multiple thermal end uses (e.g., space heating, space cooling, water heating) while being more energy efficient than traditional heat pumps in a cold climate setting. The modular ccHP system includes a heat pump module, a thermal energy storage (TES) module, and at least one end use module. These modules may be connected by at least one heat transfer fluid loop. The end use modules can be selected based on the outdoor climate and/or end-use load needs present. The modular ccHP substantially maximizes the use of available energy by using superheated refrigerant for multiple end uses (e.g., heating water while providing space heating or cooling), using subcooled refrigerant for certain end uses (e.g., to pre-heat the domestic hot water, providing heat for an end use (e.g., space heating) while simultaneously using the refrigerant sub-cooler to charge (i.e., melt) a phase change material (PCM) in the TES module, and eliminating the need for backup electric resistance heating during defrost.

As used herein, a “cold climate” is defined as a region with more than approximately 9,000 heating degree days (on a 65° F. basis). Heating degree days are a measure of how cold the temperature was on a given day during a period of days. Although the system herein is referred to as a modular ccHP system, the system of the present disclosure could be used in climates which are not typically considered “cold climates.” The location/climate for the use of the modular ccHP system as described herein is not intended to be limited to any one geographic area, climate, or altitude.

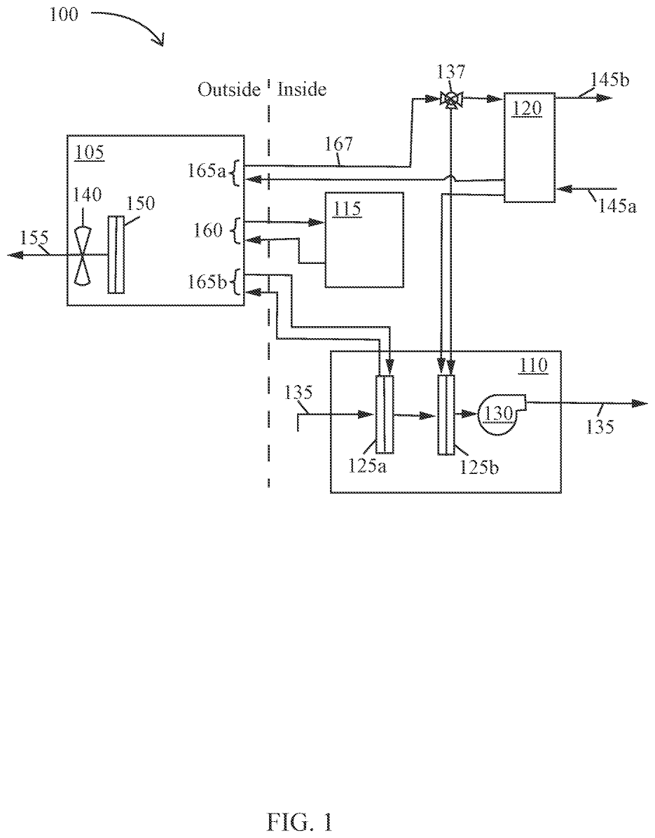

FIG. 1 illustrates a modular ccHP system 100, according to some aspects of the present disclosure. The modular ccHP system 100 includes a heat pump module 105 and a TES module 115 which may be connected to the heat pump module 105 by a heat transfer fluid 167 at a first connection 160. The modular ccHP system 100 may also include at least one end use module (shown in FIG. 1 as an air handing unit (AHU) module 110 and a hot water tank 120) connected to the heat pump module 105 with a heat transfer fluid 167 by a second connection (shown in FIG. 1 as 165a for the hot water tank 120 and 165b for the AHU module 110). In the example shown in FIG. 1, the end use modules are a domestic water hot water tank 120 and an air handing unit (AHU) module 110, but other end use modules may be used.

In exemplary system 100 shown in FIG. 1, AHU coil 125a is shown as being connected to the heat pump module 105 via second connection 165b. This is how the heat pump module 105 may directly heat an airstream 135, which may be for space heating applications. In some embodiments of the exemplary system 100 shown in FIG. 1, AHU coil 125b receives a heat transfer fluid from the second connection 165a directed towards the hot water tank 120, by valve 137 redirecting the heat transfer fluid, or from heat transfer fluid exiting the hot water tank 120. This may be based on the heating needs of airstream 135. When additional heat is needed, a portion of the superheated heat transfer fluid from the second connection 165a may be directed to the AHU coil 125b. In other instances when space cooling is needed, a heat transfer fluid exiting the hot water tank 120 may be directed to the AHU coil 125b to assist in cooling the airstream 135. In either situation, a blower 130 may direct the airstream 135 back to its intended use space.

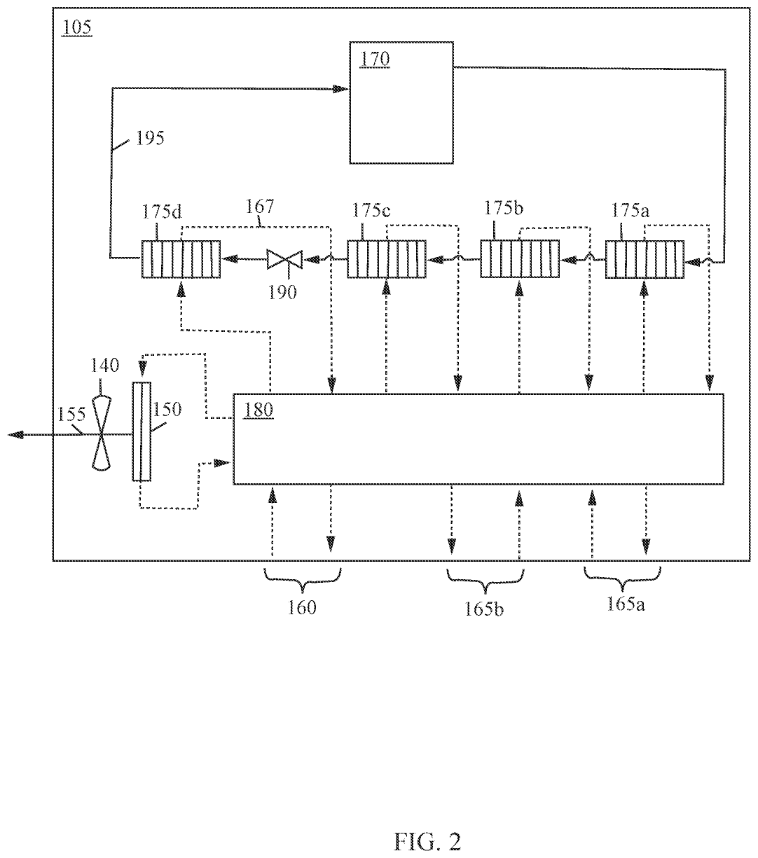

In some embodiments, in the heat pump module 105, a heat pump coil 150 and fan 140 may release exhaust air 155 into the external ambient. Using heat from the TES module 115, frost on the heat pump coil 150 may be prevented and/or removed (see FIG. 2). A typical heat pump runs in “reverse” during defrost, pulling energy (i.e., heat) from the indoor air to melt the frost on the coil. This requires a low-efficiency electric resistance backup system to avoid blowing extremely cold (for example, approximately 5° C.) air into the building during defrost. In the modular ccHP system 100 of the present disclosure, the heat pump module 105 pulls heat from the TES module 115 and pumps it to the outdoor heat pump coil 150 for defrost to remove the buildup of ice on the heat pump coil 150. Thus, it does not pull any heat from the indoor airstream 135 and does not require backup heating to continue operation of the AHU coil 125a or 125b during defrost. Thus, in some embodiments, the space heating function (i.e., the AHU module 110) of the modular ccHP system 100 can continue to operate while the heat pump module 105 is in defrost mode.

A typical heat pump takes heat from the ground or air, uses electrical energy to increase the heat, and sends it to an end use. In some embodiments, the heat pump module 105 can operate by removing heat from the ambient (via the heat pump coil 150) and, in combination with the use of electrical energy, send it to an end use module (i.e., AHU module 110 or hot water tank 120). However, in other embodiments, the heat pump module 105 may pull heat from the TES module 115 and (via the second connection 165) send the heat to an end use module. When drawing heat form the TES module 115, the heat pump module 105 may also use electrical energy to increase the heat, or may direct the heat to the end use modules without increasing the temperature of the heat. These transfers of heat may be done using the heat transfer fluid 167.

In some embodiments, the heat transfer fluid 167 used to connect the components of the modular ccHP system 100 may be a glycol (i.e., antifreeze) such as ethylene glycol or propylene glycol, or a refrigerant.

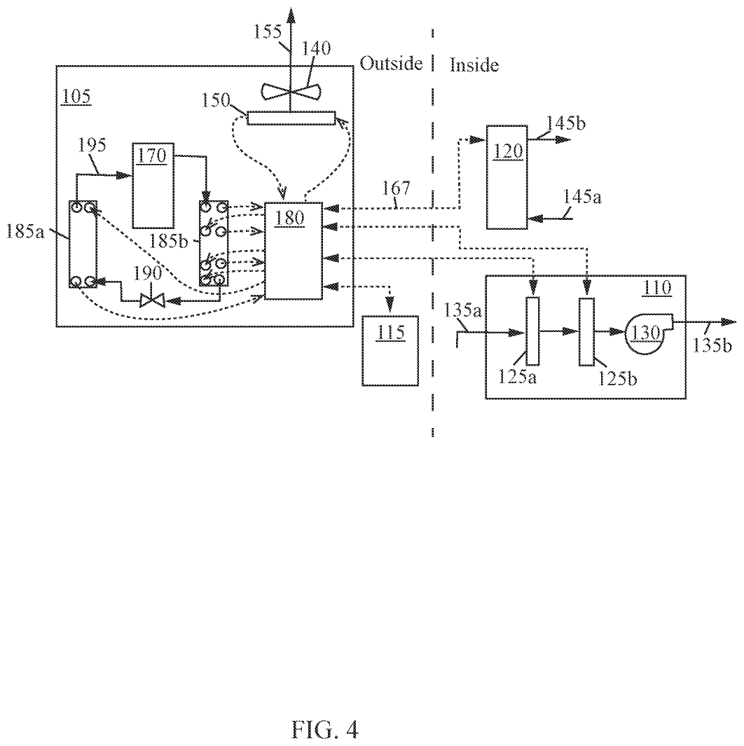

Typically, a heat pump that is a part of a building's heating and/or cooling system is installed outside of the building. In FIGS. 1 and 4 components of the modular ccHP system 100 are shown as being either outside or inside of a building. The locations are suggestions, and in some embodiments all components may be outside of the building, or all components may be inside of the building. In other embodiments, any single component may be outside of the building and any single component may be inside of the building. However, the distinctions shown in FIGS. 1 and 4 are to show how, like a traditional heat pump, in some embodiments of the modular ccHP system 100 only the heat pump module 105 is external to the building.

The modular ccHP system 100 of the present disclosure includes several new heat pump efficiency features compared to traditional R410a, direct-expansion ccHP approaches. The heat pump module 105 is a substantially self-contained vapor compression system with low refrigerant charge. Each cold or hot heat transfer fluid stream can be directed to the outdoor heat pump coil 150, TES module 115, or at least one end load module (in the example shown in FIG. 1, the AHU module 110 or the hot water tank 120). Some of the heat exchangers (for example, 175a and 175b in FIG. 2) can be removed based on the types and/or number of end use modules served by the modular ccHP system 100.

In some embodiments, the TES module 115 may be used to provide heat to the end use modules (i.e., AHU module 110 or hot water tank 120 or others) in lieu of the heat pump module 105. In this way, the operation of the modular ccHP system 100 may be more energy efficient than traditional heat pumps, by reducing the energy usage required to deliver heat to the end use modules. In some embodiments, the TES module 115 may be capable of providing in the range of about 4 hours to about 8 hours of full load management for the end use modules. The amount of time the TES module 115 may provide full load management may depend on the size of the TES module 115, the type of phase change material (PCM) used, the types of end use modules, and/or the number of end use modules.

In some embodiments, the PCM in the TES may be a composite of graphite and a salt-hydrate PCM having a conductivity of approximately 10 W/m-K. For example, a zinc nitrate hydrate (Zn(NO₃)₂·6(H₂O)—NH₄NO₃) or a tetrabutylammonium bromide (TBAB) hydrate. Other examples of salt hydrate PCMs may include potassium fluoride tetrahydrate (KF·4H₂O), manganese nitrate hexahydrate (Mn(NO₃)₂·6H₂O), calcium chloride hexahydrate (CaCl₂·6H₂O), calcium bromide hexahydrate (CaBr₂·6H₂O), lithium nitrate hexahydrate (LiNO₃·6H₂O), sodium sulfate decahydrate (Na₂SO₄·10H₂O), sodium carbonate decahydrate (NaCo₃·10H₂O), sodium orthophosphate dodecahydrate (Na₂HPO₄·12H₂O), or zinc nitrate hexahydrate (Zn(NO₃)₂·6H₂O).

FIG. 2 illustrates a heat pump module 105 for within a modular ccHP system 100, according to some aspects of the present disclosure. The heat pump module 105 includes four heat exchangers 175a, 175b, 175c, and 175d, an expansion valve 190, and a compressor 170, all connected by a refrigerant stream 195. The heat pump module 105 also includes a valve manifold 180, which directs streams of heat transfer fluid 167 to the heat exchangers 175a, 175b, 175c, and 175d, the end use modules via the first connection 160 and second connections 165a and 165b, and the heat pump coil 150.

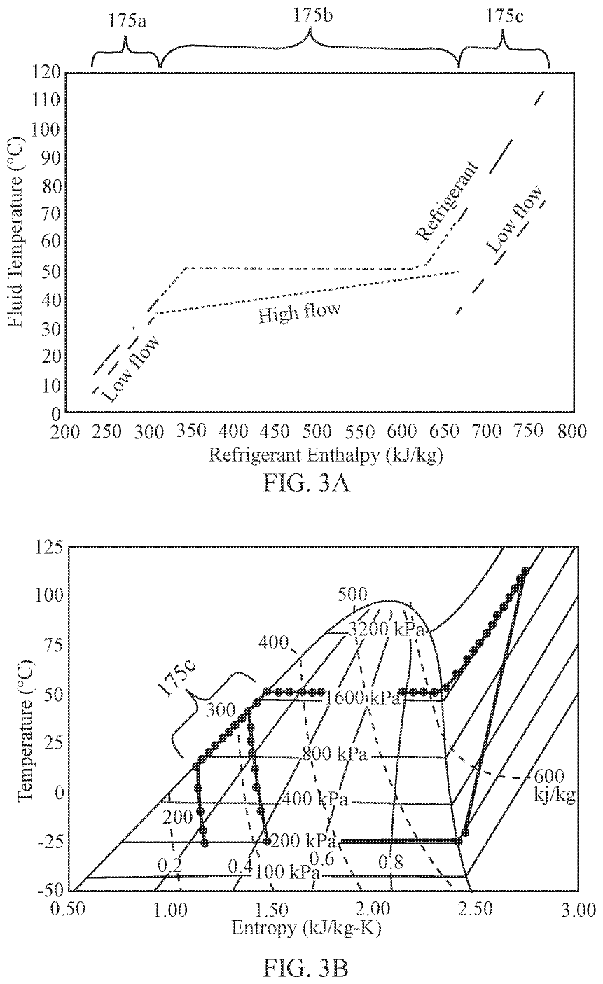

In the exemplary heat pump module 105 shown in FIG. 2, heat exchanger 175a is a refrigerant de-superheater which heats the low flow heat transfer fluid 167 stream to a temperature suitable for domestic water heating (i.e., approximately 70° C.). This heat transfer fluid stream is also useful for reheating applications when dehumidification mode is overcooling the indoor space. In FIG. 2, heat exchanger 175b a refrigerant condenser that produces a relatively high flow stream of substantially hot glycol suitable for space heating. In FIG. 2, heat exchanger 175c is a refrigerant liquid sub-cooler to pre-heat the inlet low flow glycol stream (in the range of approximately 5° C. to approximately 15° C.) sink temperature derived from domestic cold water reheat during de-humidification, or to charge (i.e., melt the PCM in the TES module 115 for later use, see FIG. 3). In FIG. 2, heat exchanger 175d is a refrigerant evaporator that operates isothermally to chill the glycol stream for space cooling, PCM freezing, or directed to the outdoor coil during heat (air source heat exchange). Valve manifold 180 directs the various streams of heat transfer fluid to the first connection 160 and second connections 165a and 165b. In the heat pump module 105, refrigerant stream 195 goes through the compressor 170 and the heat exchangers 175a, 175b, 175c, and 175d. In the heat exchangers 175a, 175b, 175c, and 175d, the refrigerant stream 195 may exchange heat with the heat transfer fluid. In FIG. 2, within the heat pump module 105 heat transfer fluid streams are indicated by dotted lines and the refrigerant stream 195 is indicated by a solid line.

In some embodiments, refrigerant stream 195 may be at least one of R290 (propane), R134a, R410A, R454B, R448A/R449A, R452B, R1234yf, R32, R717 (ammonia), or R744 (carbon dioxide). In some embodiments, the refrigerant may be a single component refrigerant. In some embodiments, the refrigerant may be blend of refrigerant fluids. In some embodiments, the refrigerant may be a blend of refrigerant fluids with a temperature glide (i.e., it does not boil at a substantially constant temperature). In some embodiments, the refrigerant may be at least one of the refrigerants listed in ASHRAE standard 34.

In some embodiments, compressor 170 in the heat pump module 105 may have up to about 5% better efficiency than traditional R410A vapor-injection compressors. For example, using R290 as the refrigerant reduces the global warming potential of the refrigerant up to about 0.02. In the exemplary heat pump module 105 shown in FIG. 2, the heat pump module 105 contains four heat exchangers 175a, 175b, 175c, and 175d to deliver heating and cooling to high and low heat transfer fluid flow streams, resulting in approximately 14% higher heat extraction from the cycle and approximately 16% higher efficiency.

In some embodiments, the installation and replacement complexity of the modular ccHP system 100 is less than traditional direct expansion (DX) split systems. Replacement of traditional refrigerant lines with heat transfer fluid 167 makes installation, maintenance, and modifications relatively simple and relatively fast requiring less training to install and repair. A lower-cost and substantially very low refrigerant charge option is also possible using the multi-segment heat exchanger and/or by removing 175a and 175c shown in FIG. 2.

In some embodiments, the modular ccHP system 100 may have many hybrid operational modes for meeting building thermal loads and shifting their electricity use via the TES module 115. For example, some operational modes may include heating, cooling, and/or cooling and reheating end use modules using the outdoor heat pump coil 150, heat from domestic hot water (i.e., from hot water tank 120), and/or the TES module 115. In some embodiments, the TES module 115 may be charged by heat from the heat pump module 105 during periods of relatively inexpensive electrical grid power, and/or using the refrigerant sub-cooler 175c during simultaneous space heating (i.e., operation of the AHU module 110). In some embodiments, when using the heat exchanger 175c to charge the TES module 115 no compressor 170 lift may be required, lowering throttling losses and capturing additional ambient heat from the evaporator (see FIG. 3). Another exemplary operational mode may include wintertime outdoor coil defrost using the TES module 115 as the source, which eliminates cold air dump into the space and the requirement for back-up heating at the AHU module 110. This mode may enable up to about 10% more space heating capacity because the space heating may not be interrupted by defrost cycles. Another exemplary operational mode is economizer modes that save energy by not using the vapor compression cycle, such as summer cooling in which the AHU module 110 is connected to the outdoor heat pump coil 150 when ambient conditions are cool or wintertime TES module 115 charging (i.e., melting) in which the TES module 115 is connected to the outdoor heat pump coil 150 when outdoor temperatures are above about the PCM transition temperature.

In some embodiments, the heat pump module 105 may be used to “charge” (i.e., melt) the PCM within the TES module 115. That is, the heat exchanger 175d may subcool the refrigerant, and heat the heat transfer fluid 167. Then, through the first connection 160 the heat transfer fluid 167 may heat the PCM (i.e., melt) within the TES module 115. That way the PCM is “charged” and prepared to be used as a source of energy/heat. The TES module 115 may be used as a source of energy/heat in lieu of the heat pump module 105 or in addition to the heat pump module 105, depending on the needs of the end use modules.

In some embodiments, the valve manifold 180 may change to which connection (i.e., first connection 160 or second connection 165) heat transfer fluid is directed at what temperatures, based on the desired end use modules, external temperature conditions, energy use preferences, or other features. For example, additional end use modules include a cooling tower for improved heat rejection in the summer, a ground loop for improved heat rejection in the summer or as a heat pump source in the winter, an additional TES module 115 with a higher transition temperature PCM for direct heating from the TES module 115 to the hot water tank 120, and/or multiple AHU modules 110 with multiple AHU coils 125 for energy recovery between building temperature zones.

In some embodiments, the valve manifold 180 may route the heat transfer fluid 167 to various end use modules (i.e., the AHU module 110 or the hot water tank 120), the heat pump module 105, and/or the TES module 115. That is, in some embodiments, the heat transfer fluid 167 may bypass any component in the modular ccHP system 100, based on the desired end uses or energy usage goals for the modular ccHP system 100. For example, in some embodiments, the only necessary end use may be hot water heating via the hot water tank 120, thus, the heat transfer fluid 167 may be directed by the valve manifold 180 from the heat pump module 105 and/or the TES module 115 (depending on the source of the heat)

The improvements in cycle efficiency using the modular ccHP system 100 may be illustrated by looking at the temperatures and refrigerant enthalpies within the heat exchanger segments (see FIGS. 3A-B). The example shown in FIGS. 3A-B illustrates how simultaneous space and water heating (i.e., substantially simultaneous use of the AHU module 110 and the hot water tank 120) uses the three heat exchanger segments effectively. Properly matching the heat transfer fluid rates with the available refrigerant heat in the three regimes of refrigerant heating (de-superheating, condensing, and sub-cooling) enables maximum heat extraction from the hot refrigerant. Heat exchanger segments 1 and 3 work in tandem to heat the heat transfer fluid to provide a low flow, high ΔT stream that is useful for water heating and re-heat for better summertime humidity control. FIGS. 3A-B also shows throttling losses present when the refrigerant is not subcooled with the incoming domestic water, which has a much higher minimum temperature. Traditional multi-function heat pumps typically do not include a sub-cooler, limiting efficiency during the combined space heating and water heating modes.

In some embodiments, the heat pump module 105 may include a compressor 170, an expansion valve 190, a condenser (not shown in FIG. 2), and an evaporator (not shown in FIG. 2). In some embodiments, the functions of a condenser and an evaporator may be performed by at least one multi-segment heat exchanger (MSHX) 185 (see FIG. 4). In some embodiments, the function of a condenser may be performed by heat exchanger 175b in FIG. 2 and the function of an evaporator may be performed by heat exchanger 175d in FIG. 2. In some embodiments, heat exchangers 175a and 175c are not present in the heat pump module 105.

In some embodiments, the heat pump module 105 includes a MSHX 185 (see FIG. 4), which enables the transfer of heat from a condensing refrigerant stream 195 such that three separate fluid streams can enter at a first temperature and flow rate to attempt to maximize the heat capacity and efficiency of the refrigeration cycle. The MSHX 185 combines the functionality of 175a, 175b, and 175c (as shown in FIG. 2) into a single device that can be constructed like a brazed plate heat exchanger (see 185a and 185b in FIG. 4). By combining the functionality of three or four traditional heat exchangers into one or two brazed plate heat exchangers. By combining the heat exchangers, less refrigerant charge and volume is required in the system 100 largely due to the more optimized use of heat exchanger area and the reduction in refrigerant that would otherwise be contained inside the connecting pipes between the three heat exchangers.

As shown in FIG. 4, the MSHX 185b acts as a condenser and accepts hot refrigerant gas (refrigerant stream 195 exiting compressor 170) to remove heat from the refrigerant stream 195 and condense it down to a sub-cooled liquid. This may be done in three heat exchanger segments (175a—refrigerant gas cooling, 175b—refrigerant condensing, and 175c—refrigerant subcooling). In this manner the three distinct temperature ranges (see FIGS. 3A-B) and heat capacities can be extracted from a single refrigerant stream within a single device (MSHX 185b). However, the thermal capacities of each refrigerant temperature range are distinct. To maximize the performance of the MSHX 185, the heat transfer fluid flowing through each segment should have a commensurate temperature change, and thus mass flow rate, to maximize the cooling of the refrigerant (i.e., maximize the heat extraction from the refrigeration cycle). The MSHX 185 allows for three distinct flow rates of heat transfer fluid, with each stream entering at a distinct temperature.

As shown in FIG. 4, the MSHX 185a acts as an evaporator taking a liquid/vapor mix of refrigerant stream 195 from the expansion valve 190 and adding heat (which may be received from the heat transfer fluid 167 from the valve manifold 180, allowing heat to be “reused” from the condenser (i.e., MSHX 185b) to the evaporator (i.e., MSHX 185a).

In some embodiments, the inlet temperature of the three heat transfer fluid streams 167 does require directing the appropriate thermal sink (i.e., end load module). This may be a domestic hot water tank 120, an air handler coil 125, a TES module 115, an outdoor heat pump coil 150, a group loop (not shown in FIG. 4), or a cooling tower (not shown in FIG. 4).

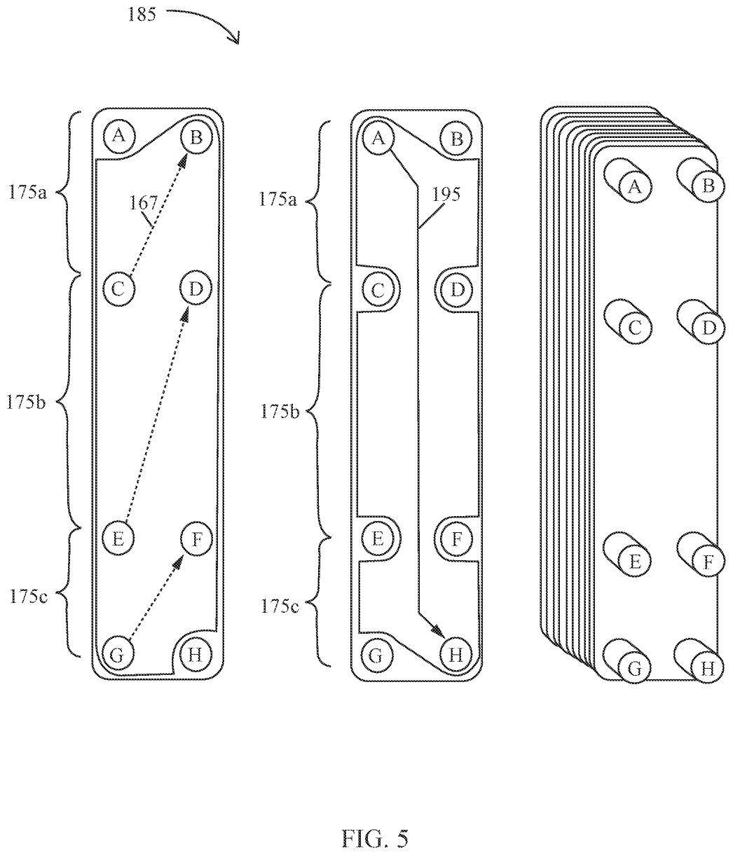

FIG. 5 illustrates three views of a MSHX 185, according to some aspects of the present disclosure. The left diagram shows the path that the three heat transfer fluid streams 167 flow within the MSHX 185. Each section of the MSHX 185 corresponding to a heat exchanger has an inlet and an outlet for the heat transfer fluid 167. The inlet port for heat exchanger 175a is port C and the outlet is port B, the inlet port for heat exchanger 175b is port E and the outlet is port D, for heat exchanger 175c, the inlet port is G and the outlet is F. In some embodiments, the heat transfer fluids 167 for each heat exchanger 175a, 175b, 175c may be different.

The middle view in FIG. 5 shows the path that the refrigerant stream 195 flows through the MSHX 185 in which the heat exchanger 175a (i.e., the first heat exchanger segment) performs refrigerant gas de-superheating (i.e., cooling) and the relatively hot gas energy the refrigerant stream 195 entering inlet port A is cooled and a fluid heat transfer fluid 167 entering heat exchanger 175a is heated. In the middle view of FIG. 5, the refrigerant stream 195 flows shown in the heat exchanger 175b (i.e., the second heat exchanger segment), refrigerant condensing occurs, because the refrigerant stream 195 exiting heat exchanger 175a begins to condense (and produce liquid refrigerant). The heat transfer fluid 167 entering heat exchanger 175b is heated. The middle view of FIG. 5 shows the refrigerant stream 195 flows through the heat exchanger 175c in which the heat exchanger 175c segment largely performs refrigerant sub-cooling, because the refrigerant stream 195 exiting heat exchanger 17b through port H is liquid and is further cooled (i.e., sub-cooled). A heat transfer fluid 167 entering heat exchanger 175b is heated.

In some embodiments, the individual heat exchangers 175a, 175b, and 175c of the MSHX 185 shown in FIG. 5 and their function (de-superheat, condensing, and sub-cooling) do not have to align. That is, in some embodiments, the segments can perform different functions. For example, in some embodiments, heat exchanger 175a can perform a fraction of the total condensing, heat exchanger 175b can perform of a fraction of the total de-superheat, heat exchanger 175b can perform a fraction of the total subcooling, and/or heat exchanger 175c can perform a fraction of the total condensing.

In some embodiments, a MSHX 185 may have two to four individual heat exchangers 175a, 175b, 175c, or 175d. The purpose of changing the number of individual heat exchangers 175a, 175b, 175c, or 175d would be to reduce or increase the number of distinct fluids through the MSHX 185 and extract a different combination of temperature range and thermal capacity from each fluid stream. In some embodiments, the heat exchangers 175a, 175b, 175c, and 175d could be constructed in series with one another such that the refrigerant exiting one heat exchanger 175a, 175b, 175c, and 175d segment will enter the next fluid stream of the next heat exchanger 175a, 175b, 175c, or 175d.

FIG. 5 shows the substantially horizontal alignment of the heat exchanger 175b heat transfer fluid 167 inlet (shown as E in FIG. 5) and heat exchanger 175c heat transfer fluid 167 outlet ports (shown as F in FIG. 5). These ports can be positioned such that the heat exchanger 175b inlet port E is substantially vertically below the heat exchanger 175c outlet port F to promote better fluid distribution and avoid forming a fluid pinch point. The same may be done for other similar pairs of heat transfer fluid 167 ports.

In some embodiments, the charge (or total mass) of refrigerant stream 195 in the modular ccHP system 100 determines the operation of the MSHX 185. The charge may be adjusted to determine where in the MSHX 185 the boundary of the liquid and condensing sections occurs. In FIG. 5, the charge of the refrigerant stream 195 determines the boundary between heat exchanger 175b and heat exchanger 175c segments.

The right view of FIG. 5 shows an isometric view of how the inner plates are stacked, brazed together, and fitted with fluid ports to connect to the rest of the vapor compression system (i.e., the heat pump module 105). The size and number of the plates of the MSHX 185 may depend on the desired temperatures of the refrigerant stream 195, the volume of refrigerant stream 195, or other factors.

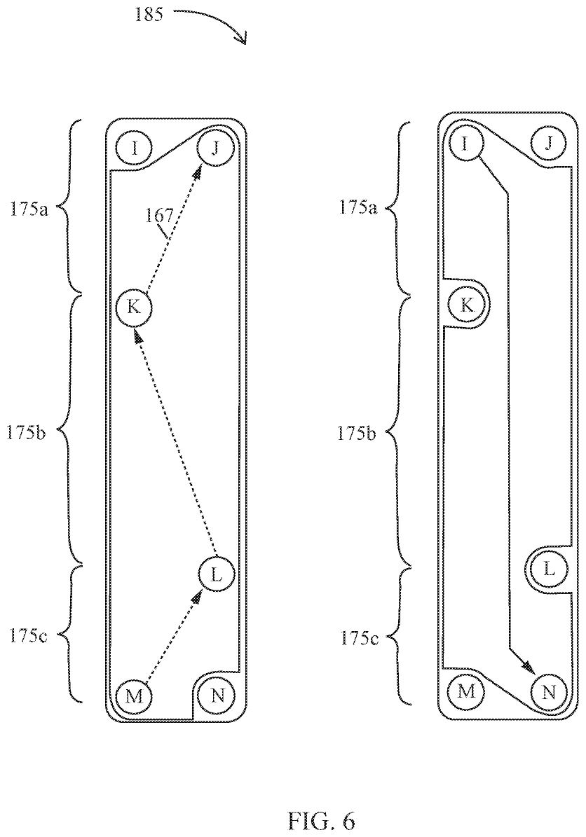

FIG. 6 illustrates a second embodiment of an MSHX 185 inner refrigerant stream 195 and heat transfer fluid 167 flow network, according to some aspects of the present disclosure. While the first embodiment (as shown in FIG. 5 is modular and contains three separate heat exchangers 175a, 175b, and 175c (and thus can use three heat transfer fluid 167 streams, which may be three different types of heat transfer fluids 167), the second embodiment shown in FIG. 6 contains a single section and a single type of heat transfer fluid 167. This means that the first embodiment (as shown in FIG. 5) is more flexible (i.e., customizable for specific situations) but also more complex (i.e., it can utilize 3 heat transfer fluid streams 167), where the second embodiment (as shown in FIG. 6) is not flexible (i.e., not customizable) but is simpler.

In FIG. 6, the first heat transfer fluid 167 stream may enter the 175c inlet port (shown as M in FIG. 6) and flow to the heat exchanger 175b/175c port (shown as L in FIG. 6). In some embodiments, a second heat transfer fluid 167 stream may enter the heat exchanger 175b/175c port L and combine with the first heat transfer fluid 167. In other embodiments, it may be a single heat transfer fluid 167 stream flowing through the MSHX 185. The path of the refrigerant stream 195 is substantially similar in the two embodiments shown in FIGS. 5 and 6, the difference is how the heat transfer fluid 167 is routed through the brazed plates. The embodiment shown in FIG. 6 may be more difficult for using the different temperature ranges for different purposes because the heat transfer fluid 167 is contained within the MSHX 185.

### EXAMPLES

Example 1. A modular cold climate heat pump system, the system comprising:
a heat pump module comprising a refrigerant;
a thermal energy storage (TES) module in thermal communication with the heat pump module via a first connection; and
an end use module in thermal communication with the heat pump module via a second connection; wherein:
the first connection and the second connection comprise a heat transfer fluid, and
the refrigerant and the heat transfer fluid are in thermal communication in the heat pump module.

Example 2. The modular cold climate heat pump system of Example 1, wherein:
the heat transfer fluid comprises at least one of ethylene glycol or propylene glycol.

Example 3. The modular cold climate heat pump system of Example 1, wherein:
the end use module comprises an air handling unit module.

Example 4. The modular cold climate heat pump system of Example 3, wherein:
the air handling unit comprises a coil and a blower, and
the air handling unit is configured to heat an airstream.

Example 5. The modular cold climate heat pump system of Example 3, wherein:
the air handling unit comprises a coil and a blower; and
the air handling unit is configured to cool an airstream.

Example 6. The modular cold climate heat pump system of Example 1, wherein:
the end use module comprises a hot water tank, and
the hot water tank is configured to heat a water stream.

Example 7. The modular cold climate heat pump system of Example 1, wherein:
the TES module comprises a phase change material.

Example 8. The modular cold climate heat pump system of Example 7, wherein:
the phase change material comprises a salt hydrate.

Example 9. The modular cold climate heat pump system of Example 8, wherein:
the salt hydrate comprises at least one of zinc nitrate hydrate (Zn(NO₃)₂·6(H₂O)—NH₄NO₃), tetrabutylammonium bromide (TBAB) hydrate, potassium fluoride tetrahydrate (KF·4H₂O), manganese nitrate hexahydrate (Mn(NO₃)₂·6H₂O), calcium chloride hexahydrate (CaCl₂·6H₂O), calcium bromide hexahydrate (CaBr₂·6H₂O), lithium nitrate hexahydrate (LiNO₃·6H₂O), sodium sulfate decahydrate (Na₂SO₄·10H₂O), sodium carbonate decahydrate (NaCo₃·10H₂O), sodium orthophosphate dodecahydrate (Na₂HPO₄·12H₂O), or zinc nitrate hexahydrate (Zn(NO₃)₂·6H₂O).

Example 10. The modular cold climate heat pump system of Example 1, wherein:
the TES module is configured to provide heat to and to receive heat from the heat pump module via the first connection.

Example 11. The modular cold climate heat pump system of Example 1, wherein:
the heat pump module comprises a valve manifold,
the valve manifold is configured to direct the heat transfer fluid to the first connection or the second connection, and
the TES module is configured to provide heat to the end use module via the first connection and the second connection.

Example 12. The modular cold climate heat pump system of Example 1, wherein:
the heat pump module comprises a coil, and
the coil is configured to receive heat from the TES module via the first connection.

Example 13. The modular cold climate heat pump system of Example 1, wherein:
the refrigerant comprises at least one of R290 (propane), R134a, R410A, R454B, R448A/R449A, R452B, R1234yf, R32, R717 (ammonia), or R744 (carbon dioxide).

Example 14. The modular cold climate heat pump system of Example 13, wherein:
the heat pump module is configured to de-superheat the refrigerant resulting in a de-superheated refrigerant.

Example 15. The modular cold climate heat pump system of Example 14, wherein:
the de-superheated refrigerant is configured to heat the heat transfer fluid to approximately 70° C.

Example 16. The modular cold climate heat pump system of Example 15, wherein:
the de-superheated refrigerant is configured to heat the heat transfer fluid resulting in a heated heat transfer fluid, and
the heated heat transfer fluid is configured to heat the end use module via the second connection.

Example 17. The modular cold climate heat pump system of Example 16, wherein:
the end use module comprises a hot water tank.

Example 18. The modular cold climate heat pump system of Example 1, wherein:
the heat pump module is configured to condense the refrigerant resulting in a condensed refrigerant.

Example 19. The modular cold climate heat pump system of Example 19, wherein:
the condensed refrigerant is configured to heat the heat transfer fluid resulting in a heated heat transfer fluid, and
the heated heat transfer fluid is configured to heat the end use module via the second connection.

Example 20. The modular cold climate heat pump system of Example 20, wherein:
the end use module comprises an air handing unit (AHU) module.

Example 21. The modular cold climate heat pump system of Example 1, wherein:
the heat pump module is configured to sub-cool the refrigerant resulting in a subcooled refrigerant.

Example 22. The modular cold climate heat pump system of Example 21, wherein:
the subcooled refrigerant is configured to heat the heat transfer fluid resulting in a heated heat transfer fluid, and
the heated heat transfer fluid is configured to heat the TES module via the second connection.

Example 23. The modular cold climate heat pump system of Example 1, wherein:
the heat pump module comprises a multi-segmented heat exchanger (MSHX) device comprising:
   a first heat exchanger;
   a second heat exchanger; and
   a third heat exchanger; wherein:
the first heat exchanger, the second heat exchanger, and the third heat exchanger flow through at least one brazed plate, and
the first heat exchanger, the second heat exchanger, and the third heat exchanger are in thermal communication with the refrigerant.

Example 24. The modular cold climate heat pump system of Example 23, wherein:
the first heat exchanger is configured to de-superheat the refrigerant resulting in a de-superheated refrigerant.

Example 25. The modular cold climate heat pump system of Example 24, wherein:
the de-superheated refrigerant is configured to heat the heat transfer fluid to approximately 70° C.

Example 26. The modular cold climate heat pump system of Example 25, wherein:
the de-superheated refrigerant is configured to heat the heat transfer fluid resulting in a heated heat transfer fluid, and
the heated heat transfer fluid is configured to heat the end use module via the second connection.

Example 27. The modular cold climate heat pump system of Example 26, wherein:
the end use module comprises a hot water tank.

Example 28. The modular cold climate heat pump system of Example 23, wherein:
the second heat exchanger is configured to condense the refrigerant resulting in a condensed refrigerant.

Example 29. The modular cold climate heat pump system of Example 28, wherein:
the condensed refrigerant is configured to heat the heat transfer fluid resulting in a heated heat transfer fluid, and
the heated heat transfer fluid is configured to heat the end use module via the second connection.

Example 30. The modular cold climate heat pump system of Example 29, wherein:
the end use module comprises an air handing unit (AHU) module.

Example 31. The modular cold climate heat pump system of Example 23, wherein:
the third heat exchanger is configured to sub-cool the refrigerant resulting in a subcooled refrigerant.

Example 32. The modular cold climate heat pump system of Example 32, wherein:
the subcooled refrigerant is configured to heat the heat transfer fluid resulting in a heated heat transfer fluid, and
the heated heat transfer fluid is configured to heat the TES module via the second connection.

Example 33. A multi-segmented heat exchanger (MSHX) device comprising:
a first heat exchanger;
a second heat exchanger; and
a third heat exchanger; wherein:
the first heat exchanger, the second heat exchanger, and the third heat exchanger flow through at least one brazed plate, and
the first heat exchanger, the second heat exchanger, and the third heat exchanger are in thermal communication with a refrigerant and a heat transfer fluid.

Example 34. The MSHX device of Example 33, wherein:
the first heat exchanger is configured to de-superheat the refrigerant resulting in a de-superheated refrigerant.

Example 35. The MSHX device of Example 34, wherein:
the de-superheated refrigerant is configured to heat the heat transfer fluid to approximately 70° C.

Example 36. The MSHX device of Example 34, wherein:
the de-superheated refrigerant is configured to heat the heat transfer fluid resulting in a heated heat transfer fluid, and
the heated heat transfer fluid is configured to heat an end use module.

Example 37. The MSHX device of Example 36, wherein:
the end use module comprises a hot water tank.

Example 38. The MSHX device of Example 33, wherein:
the second heat exchanger is configured to condense the refrigerant resulting in a condensed refrigerant.

Example 39. The MSHX device of Example 38, wherein:
the condensed refrigerant is configured to heat the heat transfer fluid resulting in a heated heat transfer fluid, and
the heated heat transfer fluid is configured to heat an end use module.

Example 40. The MSHX device of Example 39, wherein:
the end use module comprises an air handing unit (AHU) module.

Example 41. The MSHX device of Example 33, wherein:
the third heat exchanger is configured to sub-cool the refrigerant resulting in a subcooled refrigerant.

Example 42. The MSHX device of Example 41, wherein:
the subcooled refrigerant is configured to heat the heat transfer fluid resulting in a heated heat transfer fluid, and
the heated heat transfer fluid is configured to heat a thermal energy storage module.

Example 43. The MSHX device of Example 33, wherein:
the heat transfer fluid comprises at least one of ethylene glycol or propylene glycol.

Example 44. The MSHX device of Example 33, wherein:
the refrigerant comprises at least one of R290 (propane), R134a, R410A, R454B, R448A/R449A, R452B, R1234yf, R32, R717 (ammonia), or R744 (carbon dioxide).

Example 45. The MSHX device of Example 33, wherein:
the heat transfer fluid comprises a glycol, and
the refrigerant comprises a propane.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A modular cold climate heat pump system, the system comprising:
a heat pump module comprising a refrigerant;
a thermal energy storage (TES) module in thermal communication with the heat pump module via a first connection; and
an end use module in thermal communication with the heat pump module via a second connection; wherein:
the first connection and the second connection comprise a heat transfer fluid, and
the refrigerant and the heat transfer fluid are in thermal communication in the heat pump module.

2. The modular cold climate heat pump system of claim 1, wherein:
the heat transfer fluid comprises at least one of ethylene glycol or propylene glycol.

3. The modular cold climate heat pump system of claim 1, wherein:
the end use module comprises an air handling unit module configured to heat an airstream.

4. The modular cold climate heat pump system of claim 1, wherein:
the end use module comprises a hot water tank, and
the hot water tank is configured to heat a water stream.

5. The modular cold climate heat pump system of claim 1, wherein:
the TES module comprises a phase change material, and
the phase change material comprises a salt hydrate.

6. The modular cold climate heat pump system of claim 1, wherein:
the heat pump module comprises a valve manifold,
the valve manifold is configured to direct the heat transfer fluid to the first connection or the second connection, and
the TES module is configured to provide heat to the end use module via the first connection and the second connection.

7. The modular cold climate heat pump system of claim 1, wherein:
the heat pump module comprises a coil, and
the coil is configured to receive heat from the TES module via the first connection.

8. The modular cold climate heat pump system of claim 1, wherein:
the refrigerant comprises at least one of R290 (propane), R134a, R410A, R454B, R448A/R449A, R452B, R1234yf, R32, R717 (ammonia), or R744 (carbon dioxide).

9. The modular cold climate heat pump system of claim 1, wherein:
the heat pump module comprises a multi-segmented heat exchanger (MSHX) device comprising:
a first heat exchanger;
a second heat exchanger; and
a third heat exchanger; wherein:
the first heat exchanger, the second heat exchanger, and the third heat exchanger flow through at least one brazed plate, and
the first heat exchanger, the second heat exchanger, and the third heat exchanger are in thermal communication with the refrigerant.

10. The modular cold climate heat pump system of claim 9, wherein:
the first heat exchanger is configured to de-superheat the refrigerant resulting in a de-superheated refrigerant,
the de-superheated refrigerant is configured to heat the heat transfer fluid resulting in a heated heat transfer fluid, and
the heated heat transfer fluid is configured to heat the end use module via the second connection.

11. The modular cold climate heat pump system of claim 10, wherein:
the end use module comprises a hot water tank.

12. The modular cold climate heat pump system of claim 9, wherein:
the second heat exchanger is configured to condense the refrigerant resulting in a condensed refrigerant,
the condensed refrigerant is configured to heat the heat transfer fluid resulting in a heated heat transfer fluid, and
the heated heat transfer fluid is configured to heat the end use module via the second connection.

13. The modular cold climate heat pump system of claim 9, wherein:
the third heat exchanger is configured to sub-cool the refrigerant resulting in a subcooled refrigerant,
the subcooled refrigerant is configured to heat the heat transfer fluid resulting in a heated heat transfer fluid, and
the heated heat transfer fluid is configured to heat the TES module via the second connection.

14. A multi-segmented heat exchanger (MSHX) device comprising:
a first heat exchanger;
a second heat exchanger; and
a third heat exchanger; wherein:
the first heat exchanger, the second heat exchanger, and the third heat exchanger flow through at least one brazed plate, and
the first heat exchanger, the second heat exchanger, and the third heat exchanger are in thermal communication with a refrigerant and a heat transfer fluid.

15. The MSHX device of claim 14, wherein:
the first heat exchanger is configured to de-superheat the refrigerant resulting in a de-superheated refrigerant,
the de-superheated refrigerant is configured to heat the heat transfer fluid resulting in a heated heat transfer fluid, and
the heated heat transfer fluid is configured to heat an end use module.

16. The MSHX device of claim 15, wherein:
the end use module comprises a hot water tank.

17. The MSHX device of claim 14, wherein:
the second heat exchanger is configured to condense the refrigerant resulting in a condensed refrigerant,
the condensed refrigerant is configured to heat the heat transfer fluid resulting in a heated heat transfer fluid, and
the heated heat transfer fluid is configured to heat an end use module.

18. The MSHX device of claim 17, wherein:
the end use module comprises an air handing unit (AHU) module.

19. The MSHX device of claim 14, wherein:
the third heat exchanger is configured to sub-cool the refrigerant resulting in a subcooled refrigerant,
the subcooled refrigerant is configured to heat the heat transfer fluid resulting in a heated heat transfer fluid, and
the heated heat transfer fluid is configured to heat a thermal energy storage module.

20. The MSHX device of claim 14, wherein:
the refrigerant comprises at least one of R290 (propane), R134a, R410A, R454B, R448A/R449A, R452B, R1234yf, R32, R717 (ammonia), or R744 (carbon dioxide).
